(19) United States
(12) Patent Application Publication
(10) Pub. No.: US 2024/0286306 A1
(43) Pub. Date: Aug. 29, 2024

(54) OPTICAL-FIBER CUTTING DEVICE

(71) Applicant: SUMITOMO ELECTRIC OPTIFRONTIER CO., LTD., Kanagawa (JP)

(72) Inventor: Ryuichiro SATO, Yokohama-shi, Kanagawa (JP)

(21) Appl. No.: 18/573,607

(22) PCT Filed: Jun. 29, 2022
(86) PCT No.: PCT/JP2022/025995

§ 371 Date: Dec. 22, 2023

(30) Foreign Application Priority Data
Jun. 30, 2021 (JP) 2021-108579

(51) Int. Cl. B26D 5/08; G02B 6/25

(52) U.S. Cl. CPC B26D 5/08; G02B 6/25

(57) ABSTRACT

An optical fiber cleaving apparatus for cutting an optical fiber includes a blade member configured to damage the optical fiber, and a rotation mechanism configured to rotate the blade member by a predetermined angle each time the blade member damages the optical fiber. The predetermined angle is a numerical value that is not capable of dividing 360.

### TECHNICAL FIELD

The present disclosure relates to an optical-fiber cutting device, i.e., an optical fiber cleaving apparatus.

The present application claims priority based on a Japanese Application No. 2021-108579 filed on Jun. 30, 2021, contents of which are incorporated by reference in its entirety.

### BACKGROUND ART

Patent Literature 1 discloses an optical fiber cutter including a rotation control mechanism. The rotation control mechanism controls rotation of a blade member that damages an optical fiber. The blade member is provided with a rotating body such as a gear having a plurality of teeth, and the blade member is integrally rotatable with the rotating body. The blade member rotates by causing an arm of the rotation control mechanism to abut against the teeth of the rotating body and rotating the rotating body. By rotating the blade member by a predetermined angle each time the optical fiber is damaged, a position of the blade member that comes into contact with the optical fiber is shifted.

### CITATION LIST

### Patent Literature

Patent Literature 1: JP2017-156419A

### SUMMARY OF INVENTION

An optical fiber cleaving apparatus according to the present disclosure is an optical fiber cleaving apparatus for cleaving an optical fiber, the optical fiber cleaving apparatus including:

a blade member configured to damage the optical fiber; and

a rotation mechanism configured to rotate the blade member by a predetermined angle each time the blade member damages the optical fiber,
in which the predetermined angle is a numerical value that is not capable of dividing 360.

In the present disclosure, the unit of the angle is “degrees”. The value of the predetermined angle is an actual value.

“The predetermined angle is a numerical value that is not capable of dividing 360” means that the quotient, which is a calculation result of dividing 360 by the value of the predetermined angle, is not an integer.

### BRIEF DESCRIPTION OF DRAWINGS

FIG. 1 is a perspective view showing a configuration example of an optical fiber cleaving apparatus according to the present embodiment.

FIG. 2 is a view illustrating a configuration example of a rotation mechanism.

### DESCRIPTION OF EMBODIMENTS

### Technical Problem

In the optical fiber cutter disclosed in Patent Literature 1, by rotating the blade member by an angle corresponding to one tooth of the rotating body, the position of the blade member that comes into contact with the optical fiber changes. However, in the blade member, the position corresponding to the tooth of the rotating body comes into contact with the optical fiber, and the other position does not come into contact with the optical fiber.

An object of the present disclosure is to provide an optical fiber cleaving apparatus capable of extending the life of a blade member.

### Advantageous Effects of Invention

According to the present disclosure, it is possible to provide an optical fiber cleaving apparatus capable of extending the life of a blade member.

### Descriptions of Embodiments

First, aspects of the present disclosure will be listed and described.

(1) An optical fiber cleaving apparatus according to the present disclosure is an optical fiber cleaving apparatus for cleaving an optical fiber, the optical fiber cleaving apparatus including:
a blade member configured to damage the optical fiber; and
a rotation mechanism configured to rotate the blade member by a predetermined angle each time the blade member damages the optical fiber,
in which the predetermined angle is a numerical value that is not capable of dividing 360.

According to the above configuration, by rotating the blade member by a predetermined angle each time the optical fiber is damaged, the position on the blade member that comes into contact with the optical fiber changes. Further, since the predetermined angle is a numerical value that is not capable of dividing 360, the position on the blade member that comes into contact with the optical fiber during one rotation of the blade member is different from the position on the blade member that comes into contact with the optical fiber during the next rotation. In other words, while the blade member rotates a plurality of times, the positions on the blade member that come into contact with the optical fiber do not overlap. Accordingly, since a portion of the blade member that comes into contact with the optical fiber increases, the life of the blade member can be extended.

(2) The predetermined angle may be a prime number or a multiple of a prime number.

According to the above configuration, the number of rotations of the blade member increases until the positions on the blade member that come into contact with the optical fiber overlap. In other words, in order to damage the optical fiber, more positions on the blade member are used. Therefore, the life of the blade member can be extended.

(3) The predetermined angle may be a prime number.

According to the above configuration, the position on the blade member that comes into contact with the optical fiber returns to the same position only after the blade member rotates 360 times. In other words, when the blade member rotates 360 times, a result is that the optical fiber is in contact with the blade member at positions different from each other by 1 degree. Accordingly, since the blade member comes into contact with the optical fiber over the entire circumference thereof, the life of the blade member can be further extended.

(4) The rotation mechanism may include
a first gear having a plurality of first teeth,
an abutting member configured to abut against the first teeth of the first gear and rotating the first gear,
a second gear that has a plurality of second teeth and that is rotatable integrally with the first gear, and
a third gear that has a plurality of third teeth meshing with the second teeth of the second gear and that is rotatable integrally with the blade member,
the number of the first teeth may be different from the number of the second teeth, and
the number of the first teeth and the number of the second teeth may be smaller than the number of the third teeth.

According to the above configuration, the third gear is rotated by the second gear having the second teeth, the number of which is different from that of the first teeth of the first gear. Therefore, it is possible to rotate the blade member by a predetermined angle. The predetermined angle is a numerical value that is not capable of dividing 360. The first gear can be reliably rotated by causing the abutting member to abut against the first teeth of the first gear. Since the number of teeth of the first gear and the second gear is smaller than the number of teeth of the third gear, the first gear and the second gear can be smaller than the third gear. Accordingly, it is possible to secure a space for providing the first gear and the second gear in the optical fiber cleaving apparatus, and it is possible to prevent an increase in the size of the optical fiber cleaving apparatus.

### Details of Embodiments

Hereinafter, an embodiment of the present disclosure will be described in detail with reference to the accompanying drawings. In the description of the drawings, the same or corresponding elements are denoted by the same reference signs, and the redundant description is omitted. The dimensions of members shown in the drawings may be different from the actual dimensions of the members for convenience of description. In terms of the dimensions of the members shown in the drawings, the dimensions of the members between the drawings may be different for convenience of description.

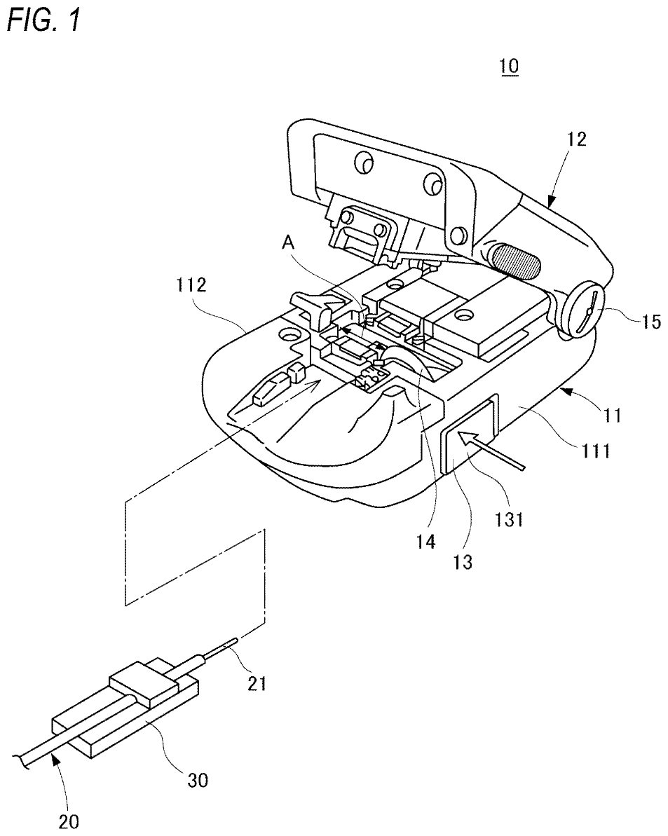

FIG. 1 is a perspective view showing a configuration example of an optical fiber cleaving apparatus 10 according to the present embodiment. The optical fiber cleaving apparatus 10 is used to cleave an optical fiber 20. As illustrated in FIG. 1, the optical fiber cleaving apparatus 10 includes a base 11, a lid 12, a slider 13, and a blade member 14.

The base 11 movably supports the blade member 14 in a predetermined direction (a direction A in FIG. 1). The base 11 defines a position of the optical fiber 20. Specifically, a fiber holder 30 holding the optical fiber 20 is positioned on an upper surface of the base 11 such that a glass fiber 21 exposed at the tip of the optical fiber 20 crosses the direction A in which the blade member 14 moves. The lid 12 is openably and closably attached to the base 11. For example, the lid 12 is rotatably coupled to one end of the base 11 via a hinge member 15.

The slider 13 is supported on the base 11 in a manner of being movable in the predetermined direction (the direction A in FIG. 1). When one end portion 131 of the slider 13 exposed on a first side surface 111 of the base 11 is pressed, the slider 13 slides along a pressing direction. A spring member (not shown) that biases the slider 13 in a direction of pushing back the slider 13 is provided at the other end portion of the slider 13. The slider 13 is normally located at an initial position as shown in FIG. 1 by a biasing force of the spring member.

The blade member 14 is a disk-shaped blade that damages the glass fiber 21 of the optical fiber 20. The blade member 14 is rotatably attached to the slider 13 and moves together with the slider 13.

When the optical fiber 20 is cleaved, the one end portion 131 of the slider 13 is pushed in in a state in which the lid 12 is opened. When the slider 13 is pressed to move toward a second side surface 112 of the base 11 and reaches a cleaving start position, the slider 13 is held at the cleaving start position by a locking structure (not shown) provided on the base 11.

Subsequently, the fiber holder 30 holding the optical fiber 20 is set on the base 11, and the glass fiber 21 is positioned. Thereafter, when the lid 12 is closed, a locking state of the slider 13 with respect to the base 11 is released by a locking release portion (not shown) provided on the base 11. Accordingly, the slider 13 moves toward the first side surface 111 of the base 11 and returns to the initial position by the biasing force of the spring member. At this time, by moving the blade member 14 together with the slider 13, the blade of the blade member 14 comes into contact with the glass fiber 21, and the glass fiber 21 is damaged.

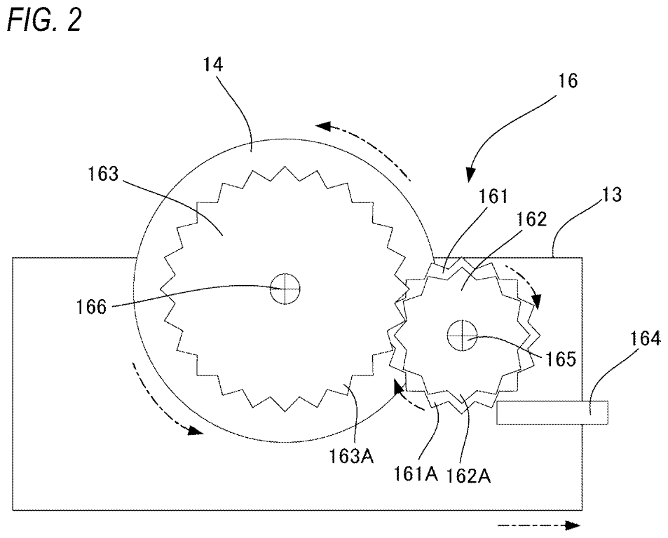

The position of the blade member 14 that comes into contact with the glass fiber 21 is updated each time the blade member 14 damages the glass fiber 21. Specifically, as shown in FIG. 2, the optical fiber cleaving apparatus 10 further includes a rotation mechanism 16. The rotation mechanism 16 rotates the blade member 14 by a predetermined angle each time the blade member 14 damages the glass fiber 21. The rotation mechanism 16 is implemented such that the predetermined angle is a numerical value that is not capable of dividing 360. In the present disclosure, the unit of the angle is “degrees”. The “predetermined angle” includes not only a design value and a set value but also an angle at which the blade member 14 actually rotates. When a certain specific predetermined angle is set as a design value or a set value, an angle at which the blade member actually rotates, including variations in manufacturing and mechanism configuration, is also included in a specific predetermined angle in the design value and the set value. When the angle at which the blade member 14 actually rotates is the certain specific predetermined angle, an angle including an angle variation in an actual operation is included in the specific predetermined angle. “The predetermined angle is a numerical value that is not capable of dividing 360” means that the quotient, which is a calculation result of dividing 360 by the value of the predetermined angle, is not an integer. The value of the predetermined angle is a real value, and may be a natural number.

For example, as shown in FIG. 2, the rotation mechanism 16 includes a first gear 161, a second gear 162, a third gear 163, and an abutting member 164.

The first gear 161 has a plurality of first teeth 161A formed continuously in a circumferential direction of the first gear 161. The second gear 162 has a plurality of second teeth 162A formed continuously in a circumferential direction of the second teeth 162. The first gear 161 and the second gear 162 are formed such that the number of the first teeth 161A and the number of the second teeth 162A are different. The first gear 161 and the second gear 162 are integrally rotatable. For example, the first gear 161 and the second gear 162 may have a monolithic structure by being integrally molded, or may be integrated by being joined together. In this example, the first gear 161 and the second gear 162 are rotatable coaxially, and are rotatably attached to the slider 13 by a screw 165 that passes through the center of a rotation shaft.

The third gear 163 is rotatable integrally with the blade member 14. For example, the third gear 163 is integrated with the blade member 14 by fitting a protrusion (not shown) protruding to a surface facing the blade member 14 to a hole (not shown) formed in the surface facing the blade member 14. In this example, the integrated third gear 163 and disk-shaped blade member 14 are coaxially rotatable, and are rotatably attached to the slider 13 by a screw 166 passing through the center thereof.

The third gear 163 has a plurality of third teeth 163A formed continuously in a circumferential direction of the third gear 163. The third gear 163 is formed such that the number of the plurality of third teeth 163A is larger than the number of the first teeth 161A and the number of the second teeth 162A. The third gear 163 is disposed such that the third teeth 163A mesh with the second teeth 162A of the second gear 162. Specifically, the blade member 14 to which the third gear 163 is attached is attached to the slider 13 such that the third teeth 163A mesh with the second teeth 162A.

The abutting member 164 abuts against the first teeth 161A of the first gear 161, and rotates the first gear 161. Specifically, the abutting member 164 rotates the first gear 161 by one tooth by abutting against the first teeth 161A of the first gear 161. For example, the abutting member 164 is fixed to the base 11, and is implemented such that the first gear 161 abuts against the abutting member 164 during movement of the blade member 14 together with the slider 13. Accordingly, the first gear 161 rotates, and the blade member 14 rotates via the second gear 162 and the third gear 163.

Specifically, as shown in FIG. 2, when the first gear 161 abuts against the abutting member 164 during movement (movement to the right in FIG. 2) of the blade member 14 together with the slider 13, the first gear 161 rotates by one tooth in one direction (clockwise in FIG. 2). Accordingly, the second gear 162 integrated with the first gear 161 rotates, and the rotation of the second gear 162 causes the third gear 163 to rotate in an opposite direction (counterclockwise in FIG. 2). As a result, the blade member 14 integrated with the third gear 163 rotates.

When the number of the first teeth 161A is Za, the number of the second teeth 162A is Zb, and the number of the third teeth 163A is Zc, a rotation angle θ1 of the third gear 163 is represented by θ1=(360/Zc)×(Zb/Za). The number of the first teeth 161A, the second teeth 162A, and the third teeth 163A is appropriately set such that the rotation angle θ1 of the third gear 163 is a numerical value that is not capable of dividing 360. For example, when Za=15, Zb=13, and Zc=24, the rotation angle θ1 of the third gear 163 can be θ1=(360/24)×(13/15)=13 degrees. Since the blade member 14 rotates integrally with the third gear 163, a rotation angle θ2 of the blade member 14 can be θ2=θ1=13 degrees. That is, the first gear 161 abuts against the abutting member 164, so that the blade member 14 rotates by the rotation angle θ2, which is a numerical value that is not capable of dividing 360.

As described above, when the blade member 14 is rotated by the rotation angle θ2 (the predetermined angle) each time the glass fiber 21 is damaged, the position on the blade member 14 that comes into contact with the glass fiber 21 changes. Further, since the rotation angle θ2 is a numerical value that is not capable of dividing 360, the position on the blade member 14 that comes into contact with the glass fiber 21 during one rotation of the blade member 14 is different from the position on the blade member 14 that comes into contact with the glass fiber 21 during the next rotation. That is, while the blade member 14 rotates a plurality of times, the positions on the blade member 14 that come into contact with the glass fiber 21 do not overlap. Therefore, since a portion of the blade member 14 that comes into contact with the glass fiber 21 increases, the life of the blade member 14 can be extended.

For example, when the rotation angle θ2 is 15 degrees which is a numerical value capable of dividing 360 degrees, the number of points on the blade member 14 that come into contact with the glass fiber 21 is 360/15=24. On the other hand, when the rotation angle θ2 is a numerical value that is not capable of dividing 360, the number of points on the blade member 14 that come into contact with the glass fiber 21 is a number obtained by dividing 360 by the greatest common divisor GCD of 360 and the rotation angle θ2. For example, when the rotation angle θ2 is 14 degrees, the number of points on the blade member 14 that come into contact with the glass fiber 21 is 360/2=180. Therefore, as compared with a case in which the rotation angle θ2 is 15 degrees, the life of the blade member 14 can be extended by 7.5 times. For example, when the rotation angle θ2 is 16 degrees, the number of points on the blade member 14 that come into contact with the glass fiber 21 is 360/8=45. Therefore, as compared with the case in which the rotation angle θ2 is 15 degrees, the life of the blade member 14 can be extended by 1.875 times. For example, when the rotation angle θ2 is 17 degrees, the number of points on the blade member 14 that come into contact with the glass fiber 21 is 360/1=360. Therefore, as compared with the case in which the rotation angle θ2 is 15 degrees, the life of the blade member 14 can be extended by 15 times. The case in which the rotation angle θ2 is 13 degrees is the same as the case in which the rotation angle θ2 is 17 degrees.

The rotation angle θ2 may be set to a prime number or a multiple of a prime number. The prime number is preferably a prime number that is not capable of dividing 360, that is, a number of 7 or more. For example, the rotation angle θ2 can be set to values such as 7, 11, 13, 14 (=7×2), 17, 19, 21 (=7×3), 22 (=11×2), 23, 26 (=13×2), 28 (=7×4), and 29.

In this case, the number of rotations of the blade member 14 increases until the positions on the blade member 14 that come into contact with the glass fiber 21 overlap. In other words, in order to damage the glass fiber 21, more positions on the blade member 14 are used. Therefore, the life of the blade member 14 can be extended. For example, as described above, as compared to the number (45) of points on the blade member 14 that come into contact with the glass fiber 21 when the rotation angle θ2 is 16 degrees that is not a prime number or a multiple of a prime number, the number (180 or 360) of points on the blade member 14 that come into contact with the glass fiber 21 when the rotation angle θ2 is 14 degrees or 17 degrees that is a prime number or a multiple of a prime number is larger. That is, the life of the blade member 14 can be further extended.

The rotation angle θ2 may be set to a prime number. For example, the rotation angle θ2 can be set to a value such as 7, 11, 13, 17, 19, 23, and 29. In this case, the position on the blade member 14 that comes into contact with the glass fiber 21 returns to the same position only after the blade member 14 rotates 360 times. That is, when the blade member 14 rotates 360 times, a result is that the glass fiber 21 is in contact with the blade member 14 at positions different from each other by 1 degree, and the number of points on the blade member 14 that come into contact with the glass fiber 21 is 360. Accordingly, the blade member 14 comes into contact with the glass fiber 21 over an entire circumference thereof while changing the position coming into contact with the glass fiber 21. Therefore, the life of the blade member 14 can be further extended.

In the present embodiment, by rotating the third gear 163 by the second gear 162 having the second teeth 162A, the number of which is different from that of the first teeth 161A of the first gear 161, it is possible to achieve a configuration in which the blade member 14 is rotated by a predetermined angle. The predetermined angle is a numerical value that is not capable of dividing 360. The first gear 161 can be reliably rotated by causing the abutting member 164 to abut against the first teeth 161A of the first gear 161. Since the number of teeth of the first gear 161 and the second gear 162 is smaller than the number of teeth of the third gear 163, the first gear 161 and the second gear 162 can be sized smaller than the third gear 163. Accordingly, it is possible to secure a space for providing the first gear 161 and the second gear 162 in the optical fiber cleaving apparatus 10, and it is possible to prevent an increase in the size of the optical fiber cleaving apparatus 10.

The diameter of the blade member 14 is preferably 57.3 times or more the diameter of the glass fiber 21. Accordingly, since a central angle of a region of the blade member 14 that comes into contact with the glass fiber 21 at one time is 1 degree or less, by setting the rotation angle θ2 (the predetermined angle) of the blade member 14 in units of 1 degree, it is possible to shift the region of the blade member 14 that comes into contact with the glass fiber 21.

Although the present disclosure has been described in detail and with reference to the specific embodiments, it will be apparent to those skilled in the art that various changes and modifications can be made without departing from the spirit and scope of the present disclosure. In addition, the number, positions, shapes, and the like of the constituent members described above are not limited to those in the above embodiment, and can be changed to suitable numbers, positions, shapes, and the like in carrying out the present disclosure.

The optical fiber cleaving apparatus 10 is not limited to the configuration shown in FIG. 1. For example, the blade member 14 is brought into contact with the glass fiber 21 using the slider 13. Alternatively, the blade member 14 may be brought into contact with the glass fiber 21 using a different mechanism.

In the above embodiment, the number Za of the first teeth 161A of the first gear 161 is larger than the number Zb of the second teeth 162A of the second gear 162. Alternatively, the number of the first teeth 161A of the first gear 161 may be smaller than the number of the second teeth 162A of the second gear 162. In this case, the same effect can also be attained by setting the number of the first teeth 161A and the number of the second teeth 162A such that the rotation angle θ1 of the third gear 163, that is, the rotation angle θ2 of the blade member 14 is a numerical value that is not capable of dividing 360.

In the above embodiment, the rotation mechanism 16 includes the first gear 161, the second gear 162, the third gear 163, and the abutting member 164. Alternatively, another configuration may be used as long as the rotation mechanism 16 can rotate the blade member 14 by the rotation angle θ2 that is a numerical value not capable of dividing 360.

In the above embodiment, the first gear 161 and the second gear 162 are coaxially rotatable. Alternatively, the first gear 161 and the second gear 162 may not be coaxial.

In the above embodiment, the third gear 163 is integrated with the blade member 14 by being attached to the blade member 14. Alternatively, the third gear 163 and the blade member 14 may have a monolithic structure by being integrally molded.

In the above embodiment, the rotation mechanism 16 rotates the blade member 14 in conjunction with the movement of the blade member 14. Specifically, the abutting member 164 is fixed to the base 11, and the first gear 161 abuts against the abutting member 164 during the movement of the blade member 14 together with the slider 13. Accordingly, the blade member 14 rotates. Alternatively, the rotation mechanism 16 may rotate the blade member 14 when the blade member 14 is stopped. Specifically, the blade member 14 may be rotated by moving the abutting member 164 and causing the abutting member 164 to abut against the first gear 16.

In the above embodiment, the blade member 14 is rotated by the predetermined angle each time the glass fiber 21 is damaged. Alternatively, regardless of whether the glass fiber 21 is actually damaged, the blade member 14 may be rotated by the predetermined angle each time the blade member 14 performs an operation that can damage the glass fiber 21.

### REFERENCE SIGNS LIST

10 optical fiber cleaving apparatus
11 base
12 lid
13 slider
14 blade member
15 hinge member
16 rotation mechanism
20 optical fiber
21 glass fiber
30 fiber holder
111 first side surface
112 second side surface
131 one end portion
161 first gear
161A first teeth
162 second gear
162A second teeth
163 third gear
163A third teeth
164 abutting member
A direction
θ1, θ2 rotation angle

What is claimed is:

1. An optical fiber cleaving apparatus for cleaving an optical fiber, the optical fiber cleaving apparatus comprising:
a blade member configured to damage the optical fiber; and
a rotation mechanism configured to rotate the blade member by a predetermined angle each time the blade member damages the optical fiber,
wherein the predetermined angle is a numerical value that is not capable of dividing 360.

2. The optical fiber cleaving apparatus according to claim 1,
wherein the predetermined angle is a prime number or a multiple of a prime number.

3. The optical fiber cleaving apparatus according to claim 2,
wherein the predetermined angle is a prime number.

4. The optical fiber cleaving apparatus according to claim 1,
wherein the rotation mechanism includes
a first gear having a plurality of first teeth,
an abutting member configured to abut against the first teeth of the first gear and rotating the first gear,
a second gear that has a plurality of second teeth and that is rotatable integrally with the first gear, and
a third gear that has a plurality of third teeth meshing with the second teeth of the second gear and that is rotatable integrally with the blade member,
wherein the number of the first teeth is different from the number of the second teeth, and
wherein the number of the first teeth and the number of the second teeth are smaller than the number of the third teeth.
